(19) United States
(12) Patent Application Publication
(10) Pub. No.: US 2016/0141852 A1
(43) Pub. Date: May 19, 2016

(54) SELF-ALIGNING BOX AND SLEEVE ASSEMBLY

(71) Applicant: Brainwave Research Corporation, Woodbridge (CA)

(72) Inventors: Jean Guy GAGNE, Etobicoke (CA); James ROGERS, Toronto (CA)

(21) Appl. No.: 14/933,811

(22) Filed: Nov. 5, 2015

Related U.S. Application Data
(60) Provisional application No. 62/076,626, filed on Nov. 7, 2014.

(51) Int. Cl. H02G 3/14; H02G 3/08; H02G 3/38; H02G 3/32

(52) U.S. Cl. CPC H02G 3/14; H02G 3/32; H02G 3/083; H02G 3/286

(57) ABSTRACT

An assembly includes an electrical box and a sleeve that is slidably engaged therewith. The box is mountable to a building wall stud so that the front of the box is aligned with the front of the stud. The inner periphery of the box provides a guide for cutting the wall substrate with the substrate mounted flush to the stud, thus defining the opening in the wall substrate. The sleeve is slidable between a retracted position, entirely within the box, and an extended position outwardly of the box aligned with the outer surface of the wall substrate.

### BACKGROUND

The benefit of provisional application 62/076,626, filed Nov. 7, 2014 on behalf of inventors Jean-Guy Gagne and James Rogers, is claimed under 35 U.S.C. 119(e). This disclosure is related to U.S. Pat. No. 9,048,640, issued Jun. 2, 2015 to inventors Jean-Guy Gagne and James Rogers.

This disclosure is related to installation of electrical components in building walls, more particularly, to installation of electrical apparatus behind a drywall substrate. Existing electrical codes require containment of line voltage electrical switches and receptacles within electrical boxes. Electrical boxes must be completely enclosed through the thickness of the drywall. A conventional structural configuration that meets the code requirements is exemplified in FIG. 1a and FIGS. 2a-3.

FIG. 1a is a rear isometric view of the exemplified installation, depicting a standard electrical box 41 mounted on stud 7 behind drywall substrate 11. FIG. 2a is a frontal isometric view of the installation. Referring to FIG. 2b, box 41 extends in an outward direction from the stud 7 through opening 43 by the thickness of the drywall 11, as can be seen in the sectional view of FIG. 2c. A conventional cover plate perimeter line 45 is illustrated. The box shown in FIG. 3 comprises device mounting tabs located on the inside of the box.

FIGS. 1b and 1c illustrate a conventional mode of installation. After box 11 has been mounted to stud 7, drywall 11 is fastened to the wall studs with screws or the like. As shown in FIG. 1b, box 41 extends outwardly from 7, while drywall 11 is flexed over box 41. Rotating cutting tool 13, shown in FIG. 1c, is used to cut the hole in drywall 11. Cutting tool 13 includes helical cutting bit 15 with guide tip 17. Opening 43 in drywall 11 is formed by running cutting bit 15 around the outside of box 41, using tip 17 as a guide against the outer wall of box 41.

Various problems may occur in performing the conventional installation. As the cutting tool is exterior to the box and not contained, guide tip 17 can wander away from the box to the extent that opening 43 will be beyond the area covered by the cover plate. Such an occurrence would require repair of the drywall. In addition, the initial drywall flexure, shown in FIG. 1b, needs to be overcome in order to make drywall 11 flush against stud 7 after the cutting process. For this purpose, the screws holding drywall 11 in place need to be tightened and additional screws near the box may be necessary. Neglect of these steps may cause popping of the screws at a subsequent time.

A further problem is presented with the use of a twisted wooden stud, a not uncommon occurrence. As shown in FIGS. 4a-4c, conventional box 41 is mounted on twisted stud 53. In FIG. 4c it can be seen that the front of box 41 is set at an angle from the plane of drywall 11. An electrical code requirement that an electrical box be enclosed through the entire thickness of the drywall would not be met. Moreover, the device that is to be installed in box 41 would not be flush with the outer surface of dry wall 11, resulting in a gap between the device and the cover plate, a result that also would be in non-compliance with the electrical code.

The conventional procedures for installation of electrical boxes and formation of substrate openings therefore thus involve a considerable expenditure of time and effort. Needs exist for a more accurate and easier way to facilitate installation of electrical devices in building walls, both in the formation of the substrate opening and in the support structure for the electrical devices. Meeting these needs should overcome the problems of the prior implementations described above.

### SUMMARY OF DISCLOSURE

The needs described above are fulfilled, at least in part, by provision of an assembly including an electrical box and a sleeve that is slidably engaged therewith. The box is mountable to a building wall stud so that the front of the box is aligned with the front of the stud. The inner periphery of the box provides a guide for cutting the wall substrate with the substrate mounted flush to the stud, thus defining the opening in the wall substrate. The sleeve is slidable between a retracted position, entirely within the box, and an extended position outwardly of the box aligned with the outer surface of the wall substrate. The sleeve may include a surface for mounting an electrical device enclosed within the box.

A wall of the box contains a slot through which a rib of the sleeve protrudes. The rib may have a T-shaped end portion to capture the rib protrusion. Corner stabilizers may be formed on the sleeve to maintain proper positioning of the sleeve within the box. Recesses in a box wall at appropriate locations correspond to the retracted and extended sleeve positions. A sprung cantilevered beam of the sleeve has a barbed end that can be engaged with the box recesses.

A recess may include a ramp configuration for easing disengagement with the barbed end of the beam to enable sliding the sleeve within the box. A tab may be fixed to the barb end to permit an installer to disengage the beam more easily. Additional recesses in the box wall permit further extended sleeve positions corresponding to different wall substrate thicknesses.

The assembly may further include a bracket that is directly mounted to the stud. First and second flexible plates extend laterally from the bracket. The box is indirectly mounted to the stud through coupling with the bracket. Respective recesses in the box may be located to pivotably receive one or more hooks in the first bracket plate and to engage one or more barbs of the second bracket plate. This arrangement is effective for installation to a twisted wall stud. The inner periphery of the box serves as the cutting guide for the wall substrate, as the side mounting portion and the first and second plates are sufficiently rigid. The plates of the bracket are sufficiently flexible to deform so that the front of the box can be flush with the inner surface of the wall substrate.

In an alternative arrangement, a sleeve assembly may be fixed to an enlarged electrical box. The sleeve assembly includes a walled enclosure within which a sleeve is engaged. An inner periphery of the enclosure provides a guide for cutting the wall substrate. The sleeve is engaged within the walled enclosure and slidable between a retracted position entirely within the box and an extended position. The front of the wall enclosure is aligned with the front of the stud when the box is mounted to the stud. In the extended position, the front end of the sleeve is aligned with the outer surface of the wall substrate.

In an alternative embodiment, a box is engageable with a bracket that is mountable to a wall stud. The bracket, which surrounds the box, has an inner periphery that provides a cutting guide for the wall substrate. The bracket contains a female threaded portion that engages with a male threaded rotatable element of the box. The rotatable element can be manipulated by an installer to advance or retract the box with respect to the bracket. The bracket can be mounted with a front end thereof in alignment with the front of the wall stud. The female threaded portion is dimensioned in length to correspond to a selective range of travel of the box between alignment with the stud and an extended position for alignment with the outer surface of the wall substrate.

Additional advantages of the present disclosure will become readily apparent to those skilled in this art from the following detailed description, wherein only the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF DRAWINGS

Various exemplary configurations are illustrated by way of example, and not by way of limitation, in the figures of the accompanying drawings in which like reference numerals refer to similar elements and in which:

FIGS. 1a, 1b and 1c are isometric, side and section views, respectively of a prior art implementation;

FIGS. 2a, 2b and 2c are isometric, front and section views, respectively of a prior art implementation;

FIG. 3 is a front view of another prior art installation;

FIGS. 4a, 4b and 4c are top, front a section views of a prior art installation with a twisted wall stud;

FIG. 5a is an isometric view of an assembly of the present disclosure;

FIG. 5b is a front view of the assembly of FIG. 5a;

FIG. 5c is a section view taken from FIG. 5b;

FIG. 5d is and exploded view of the assembly of FIG. 5a;

FIG. 6a is an isometric view of the assembly of FIG. 5a in situ;

FIGS. 6b and 6c are front and section views of the assembly shown in FIG. 6a;

FIGS. 7a 7b are isometric and front views, respectively, of the assembly of the present disclosure, illustrating a sleeve element in a retracted position;

FIG. 7c is a section view taken from FIG. 7b;

FIG. 7d is a detail view taken from FIG. 7c;

FIGS. 8a and 8b are isometric and front views, respectively, of the assembly of the present disclosure, illustrating a sleeve element in an extended position;

FIG. 8c is a section view taken from FIG. 8b;

FIG. 8d is a detail view taken from FIG. 8c;

FIG. 8e is a section view taken from FIG. 8b;

FIG. 8f is a detail view taken from FIG. 8c;

FIGS. 9a, 9b and 10 are exploded, assembled and front views of the assembly including the provision for electrical devices;

FIG. 11a is an exploded view of the assembly of the present disclosure including an additional bracket;

FIG. 11b is a plan view of the assembly of FIG. 11a;

FIG. 11c is an isometric view of the assembly of FIG. 11a as assembled;

FIG. 11d is a side view of the assembly of FIG. 11c;

FIG. 11e is a section view taken from FIG. 11d;

FIG. 12a is a plan view of the assembly of FIG. 11a in situ;

FIG. 12b is a plan view of the assembly of FIG. 11a mounted in situ;

FIGS. 13a-13c are isometric and plan views of the assembly of FIG. 11a with the addition of a vapor barrier;

FIG. 14a is an exploded isometric view of a alternative embodiment of the present disclosure;

FIG. 14b is an isometric view of the embodiment of FIG. 14 in combination;

FIG. 14c is a front view of the embodiment shown in FIG. 14b;

FIG. 14d is a section view taken from FIG. 14c;

FIGS. 14e and 14f and 14g are isometric, front and top views of the embodiment of FIG. 14a;

FIGS. 15a and 15b are isometric and front views of a further embodiment of the present disclosure;

FIG. 15c is a section view taken from FIG. 15c;

FIG. 15d is an isometric view of the embodiment of FIG. 15a in one position of the assembly;

FIG. 15e is an isometric view of the embodiment of FIG. 15a in a second position of the assembly;

FIG. 15f is a front view of the embodiment of FIG. 15a in situ;

FIG. 15g is a section view taken from FIG. 15f; and

FIG. 16 is an isometric view a collar box assembly of FIG. 15a.

### DETAILED DISCLOSURE

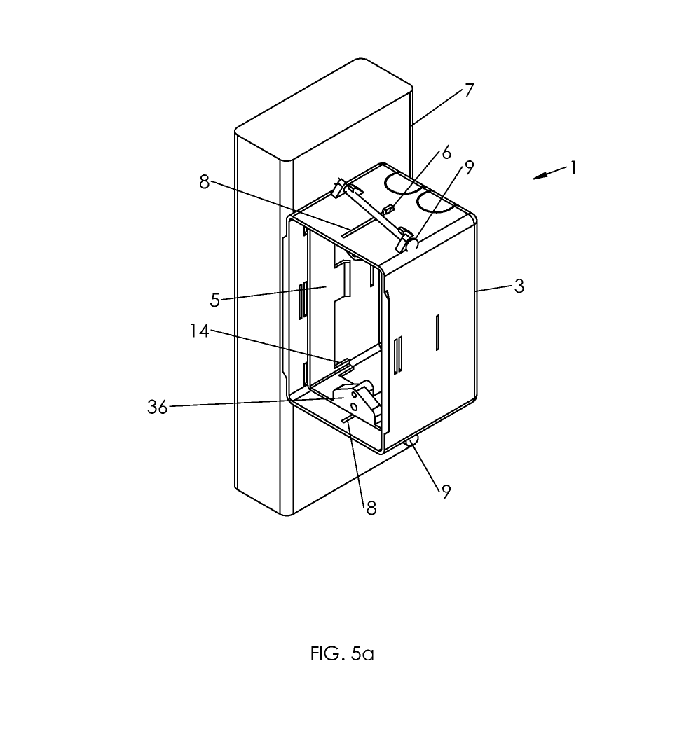

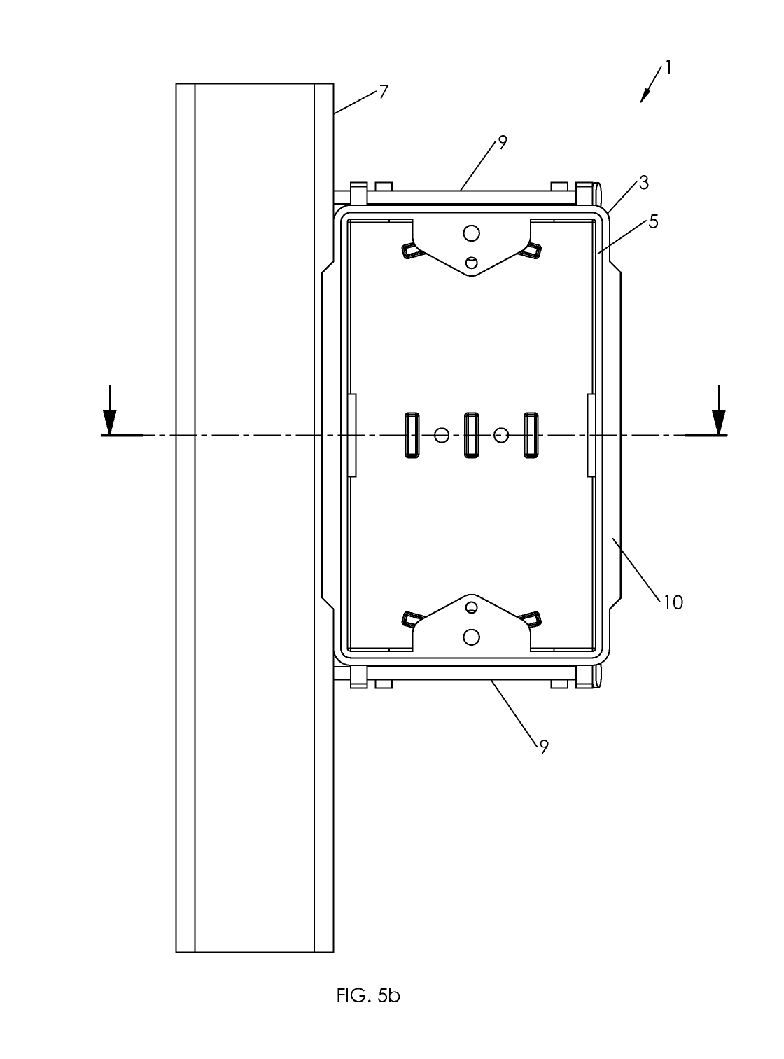

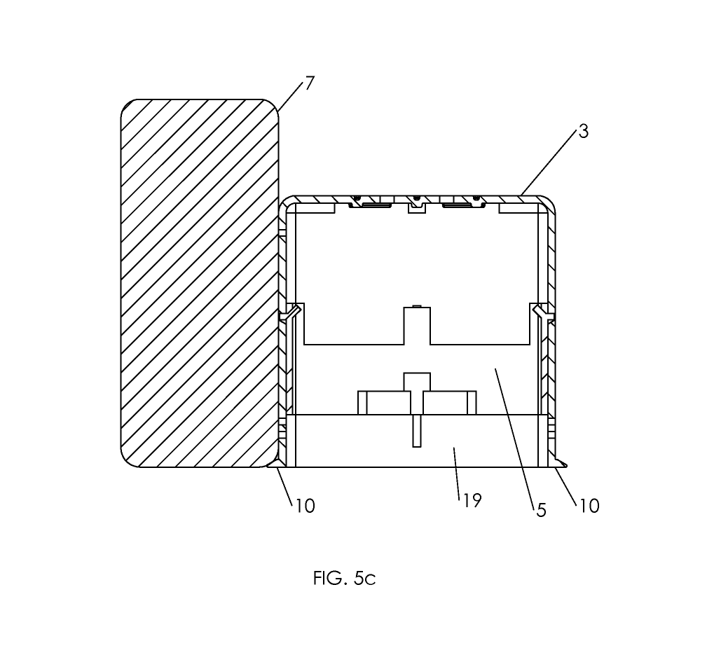

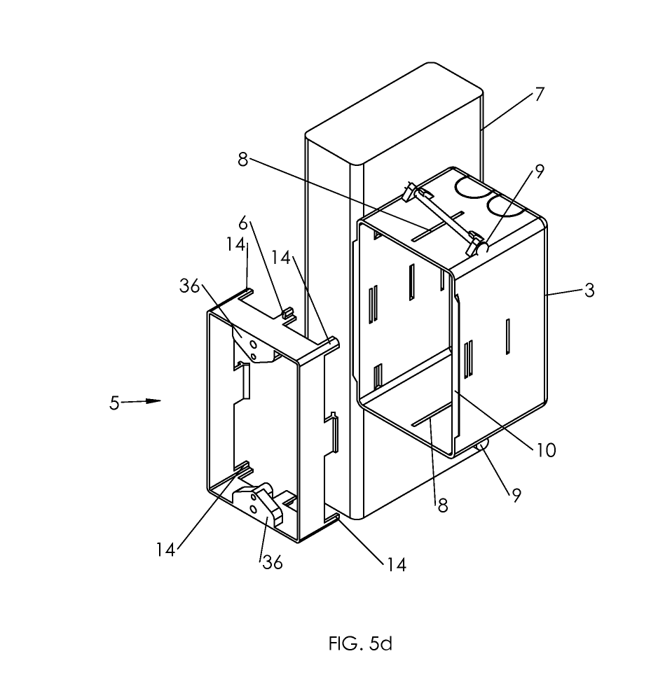

With reference to FIGS. 5a-5d, electrical box assembly 1 is fastened with nails 9 to a wall stud 7. Sleeve 5 is slideable within box 3. Sleeve 5 is shown in FIG. 5a in a retracted position prior to mounting a drywall substrate to wall studs 7. T-shaped rib 6 of sleeve 5 extends through slot 8 in box 3. As can be seen in FIG. 5c, front surface 10 of box 3 is flush with the front of stud 7. Corner stabilizers 14 of sleeve 5, shown in FIG. 5d, prevent sleeve 5 from skewing within box 3. Thus, front surface 36 of sleeve 5 slides parallel to the front surface 10 of box 3.

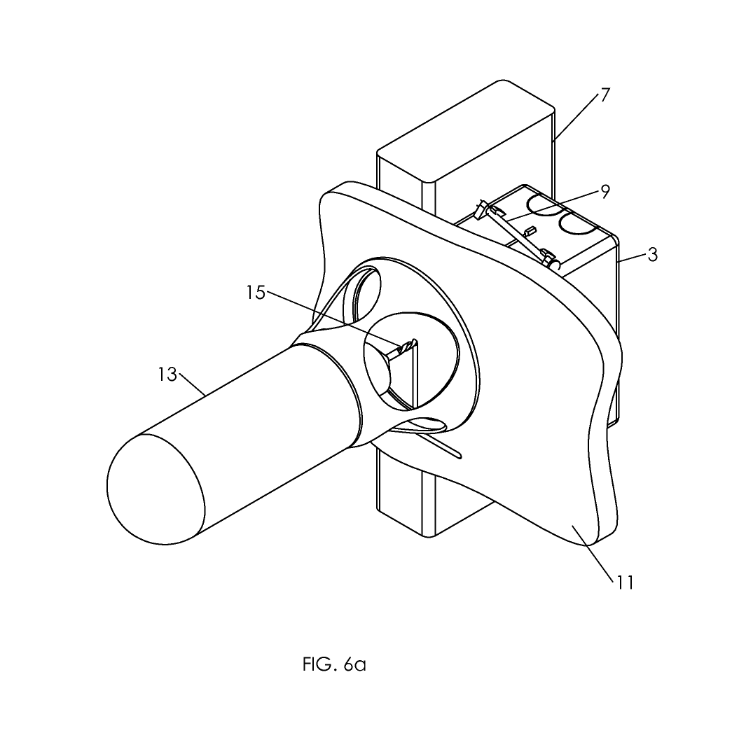

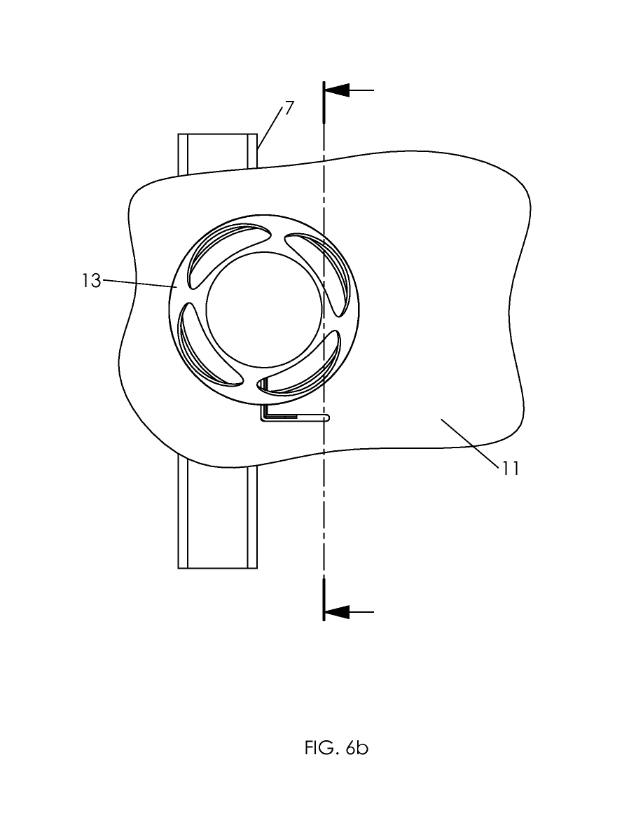

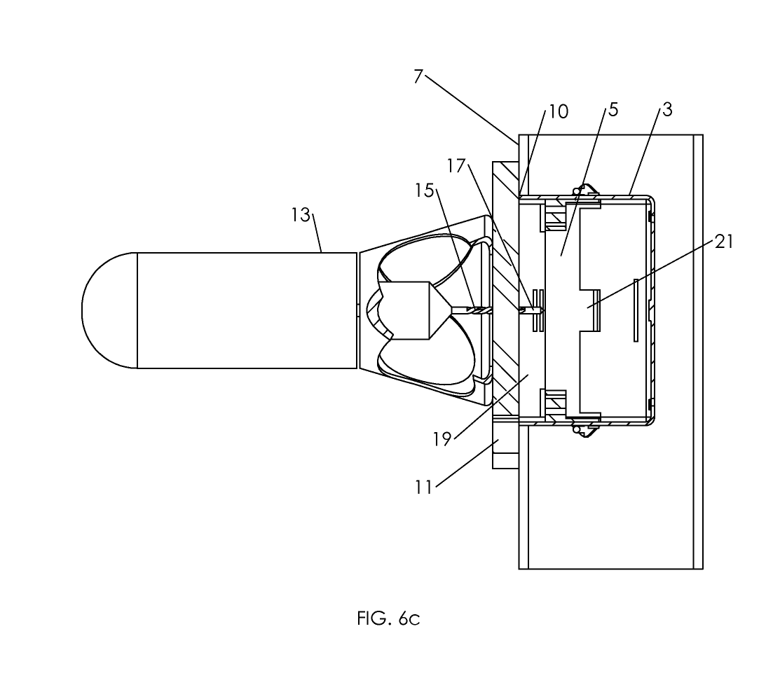

FIGS. 6a-6c are illustrative of the formation of the substrate opening. The assembly shown in FIG. 5a has been covered by drywall substrate 11. Drywall 11 is mounted to studs 7 flush with the front surface 10 of box 3. Rotating cutting tool 13 is applied to drywall 11. Helical cutting bit 15 with guide tip 17 of cutting tool 13 is used to cut the opening in drywall 11. In contrast to the above describe conventional prior art arrangements, the front opening of box 3 has a clear inner perimeter surface 19 that acts as a template for guide tip 17 of cutting bit 15 to cut the substrate to the correct size and location. Because cutting bit 15 is confined to the inside of box 3, the cutting tool bit will not wander beyond the box, thereby avoiding damage to the drywall outside of the area to be covered by a cover plate.

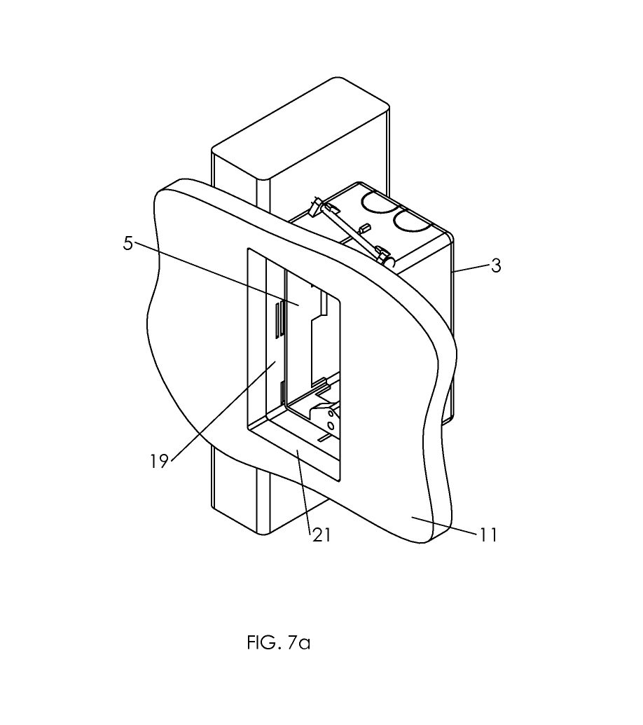

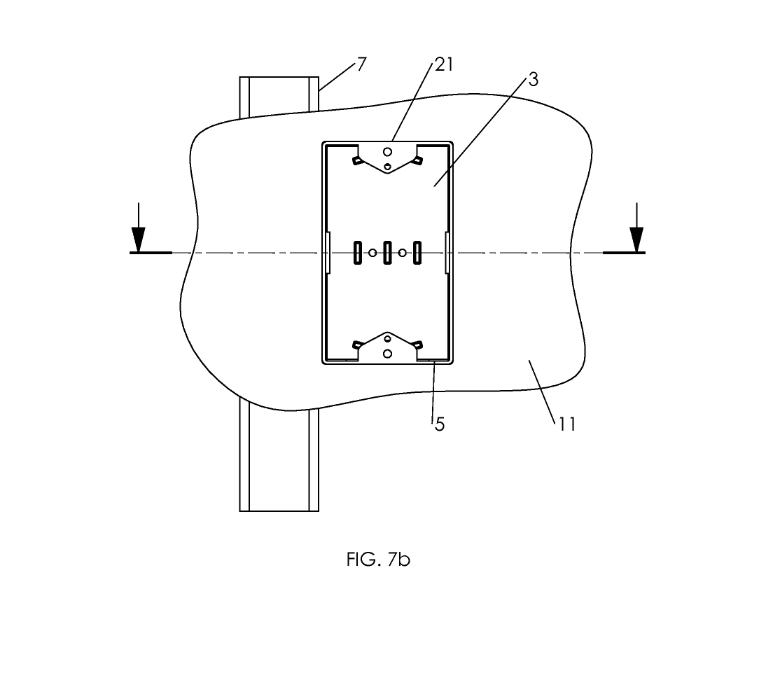

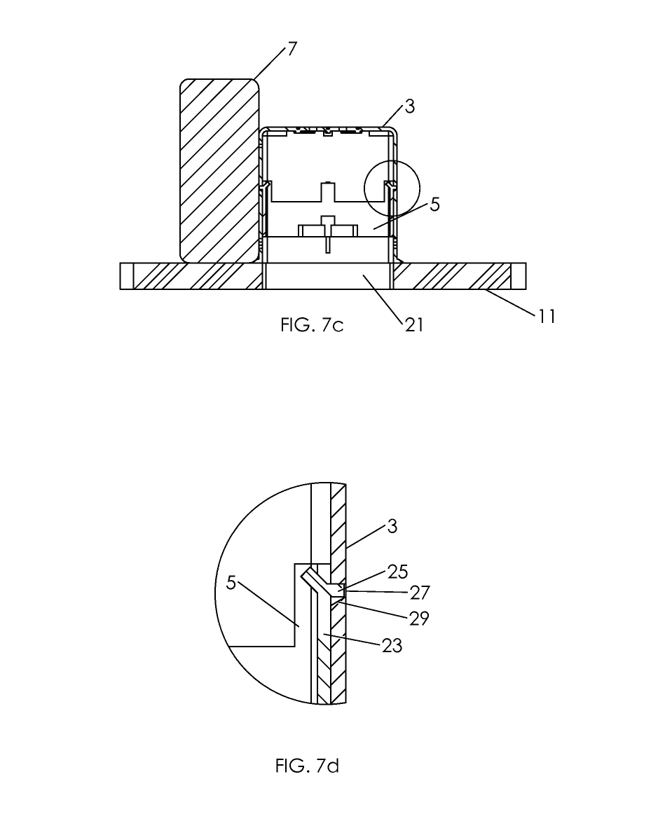

FIG. 7a is an isometric view of the assembly shown in FIG. 6a after hole 21 in drywall 11 has been cut. Sleeve 5 is still in the retracted position. FIG. 7b is a front view of the assembly shown in FIG. 7a. FIG. 7c is a section view taken from FIG. 7b. FIG. 7d is a detail view of a portion of FIG. 7c. To meet the electrical code requirement that a line voltage electrical device be completely enclosed through the thickness of the drywall, sleeve 5 is outwardly slidable to align with the front side of the drywall substrate, regardless of the particular drywall thickness.

Two commonly used drywall thicknesses are one-half inch and five-eighths inch. An advantage of the ability to selectively slide the sleeve outwardly is that the mounting of the box to the stud in the present arrangement need not take into account the drywall thickness during electrical rough-in work. As illustrated in FIGS. 7c and 7d, Sleeve 5 includes cantilevered sprung beam 23 on one or opposite side walls, having barb 25 in the end vicinity. In the retracted position shown, barbs 25 rest in recesses 27 in one or opposite walls of the box 3. Ramp 29 allows barb 27 to slide out of recess 27 as sleeve 5 is slid forward by the installer.

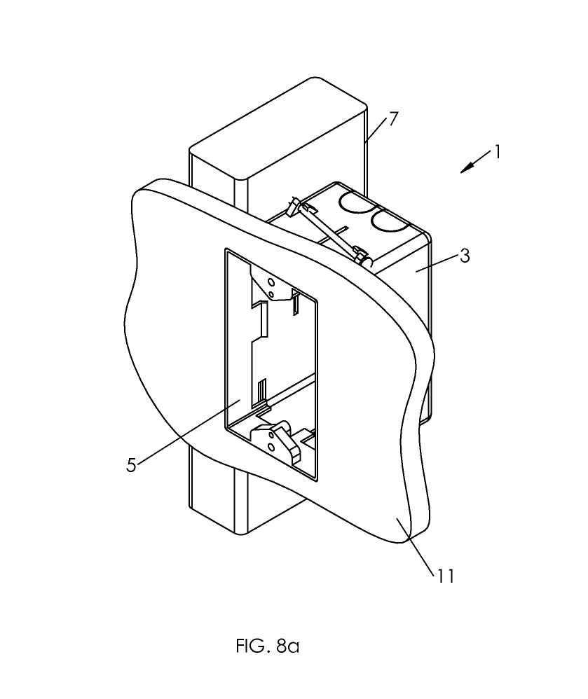

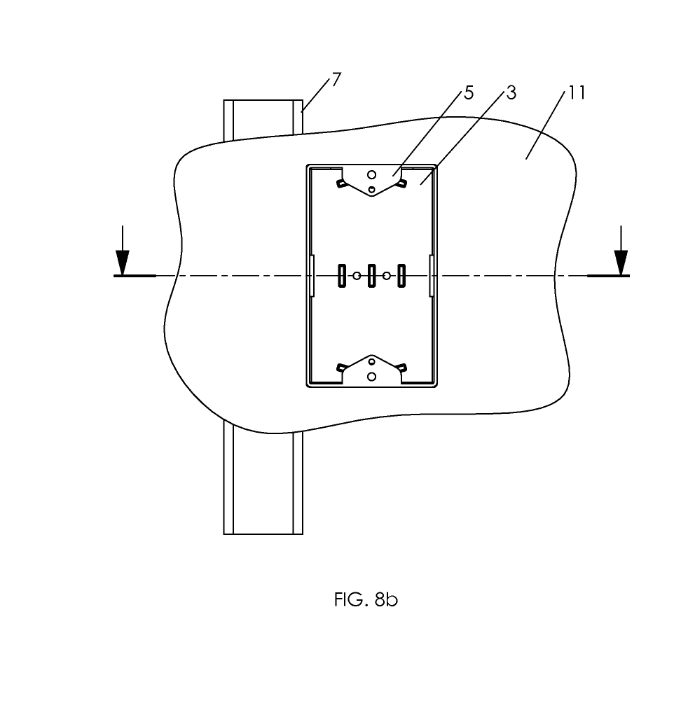

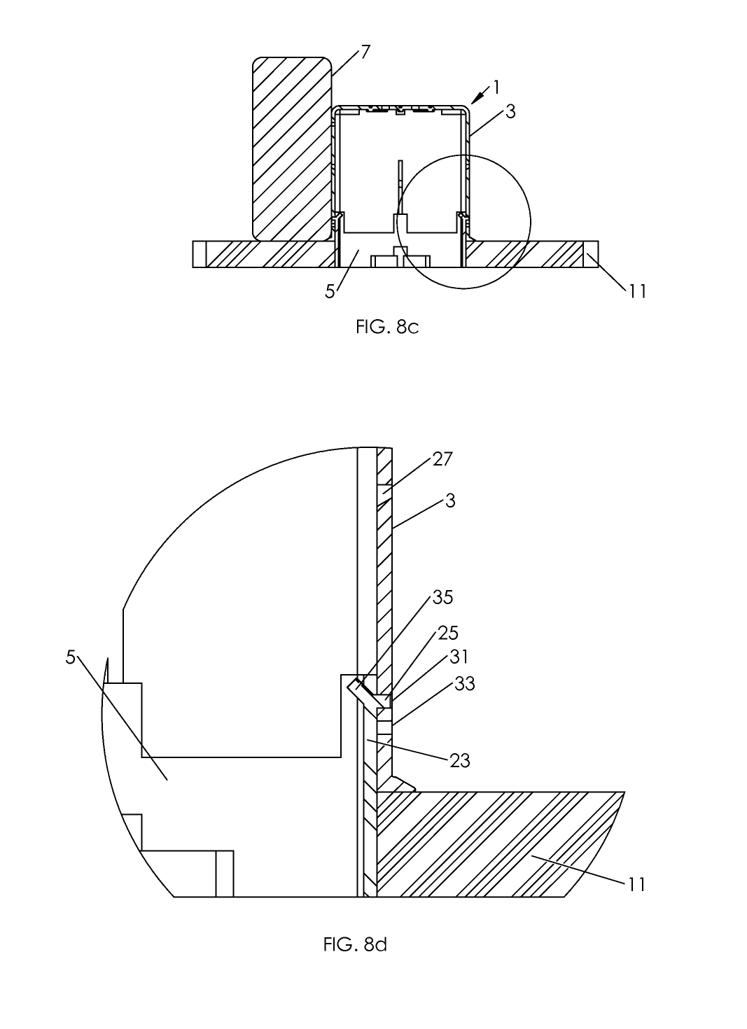

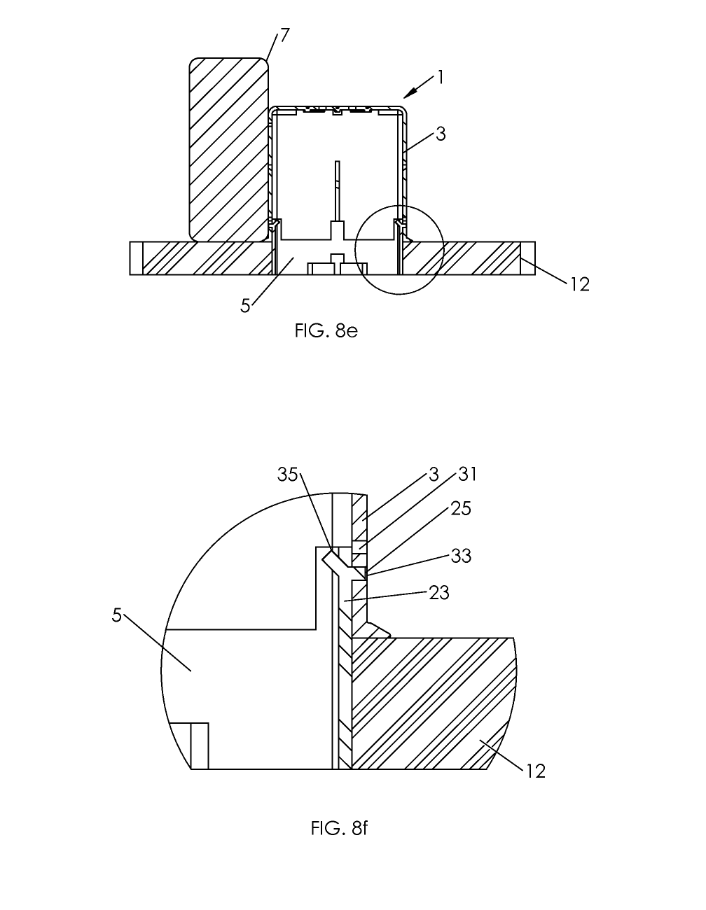

FIGS. 8a-8f illustrate the assembly shown in FIG. 7a with sleeve 5 slid forward flush with the front of drywall 11. Recesses 31 and 33 are displaced from each other along one or opposite walls of box 3, thereby accommodating substrates of two different thicknesses. Engagement of barb 25 with recess 31, as shown in FIG. 8d, corresponds to the configuration detail of FIG. 7d. That is, barb 25 first drops into recess 31 for a thinner drywall. To accommodate a thicker drywall, the installer pulls on tab 35 of beam 23 to disengage barb 25 from recess 31 and slide sleeve 5 forward to snap barb 25 into recess 33. The latter configuration is illustrated in FIGS. 8e and 8f.

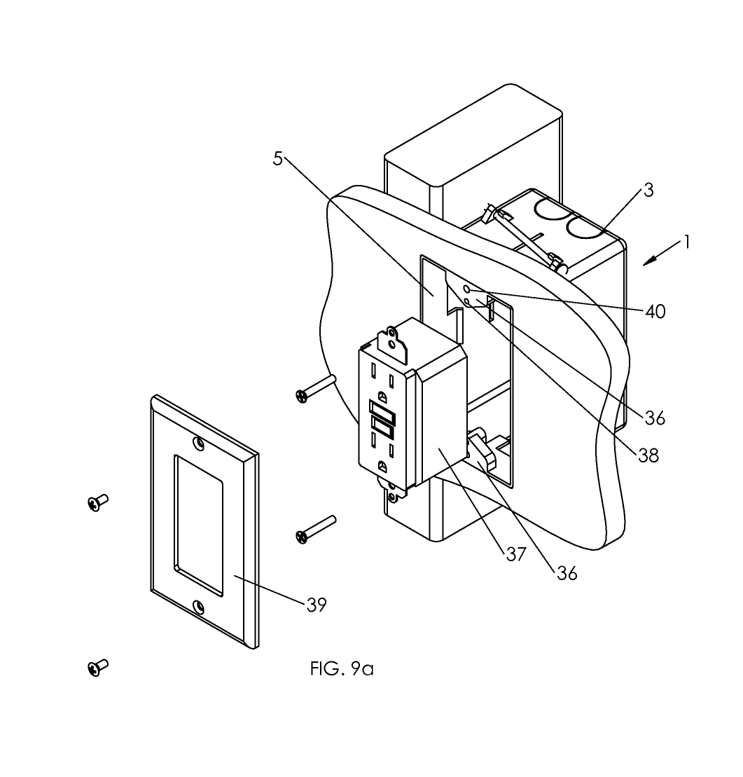

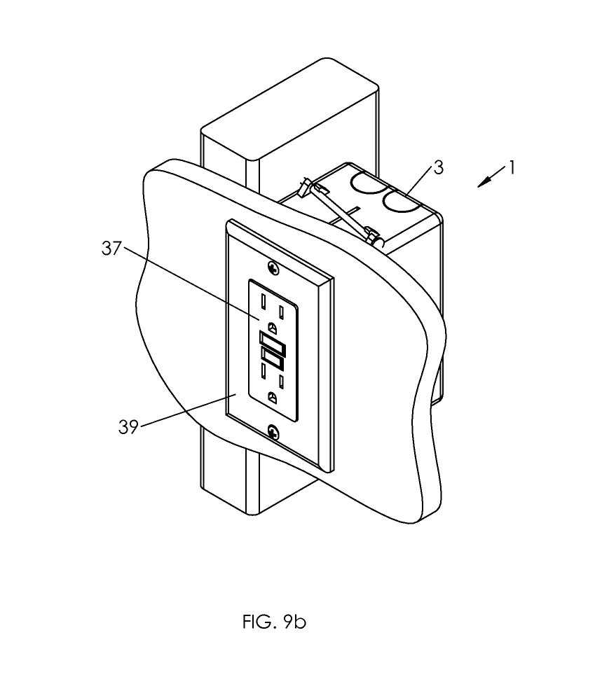

FIGS. 9a and 9b are exploded and assembled electrical box views, respectively, of assembly 1 with electrical device 37 and cover plate 39. Sleeve 5 includes mounting surface 36, device mounting holes 38 and cover plate screw clearance holes 40. Device mounting surface 36 provides a surface for the device mounting plate to rest against. The device is made stable by preventing rocking from side to side, thereby ensuring that it is installed parallel to drywall 11.

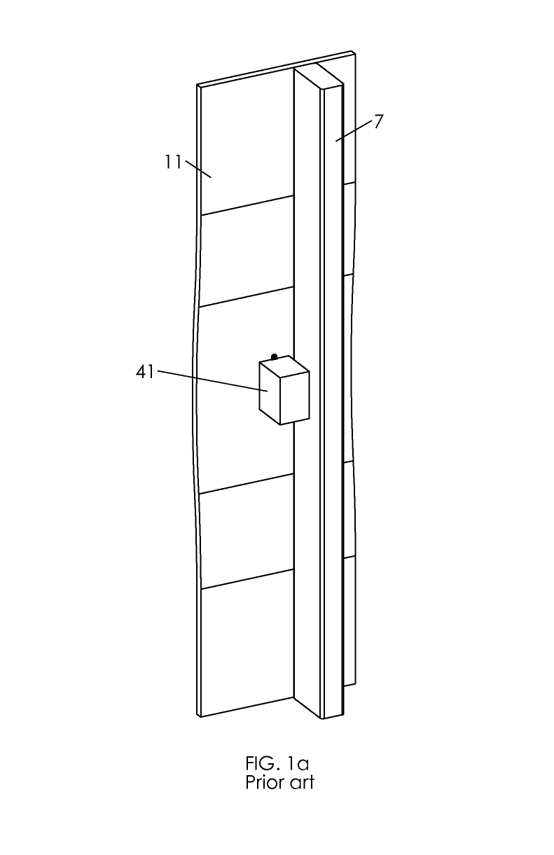

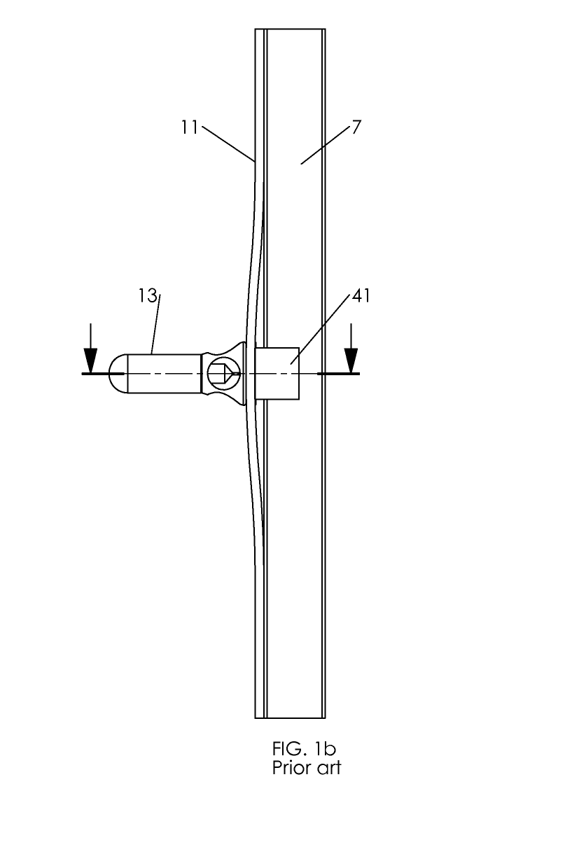

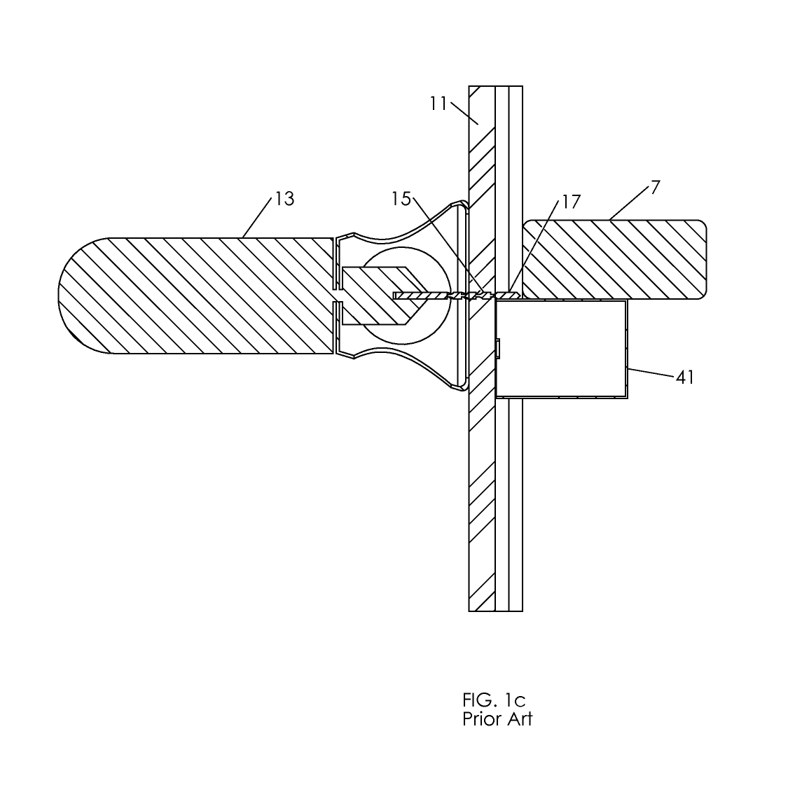

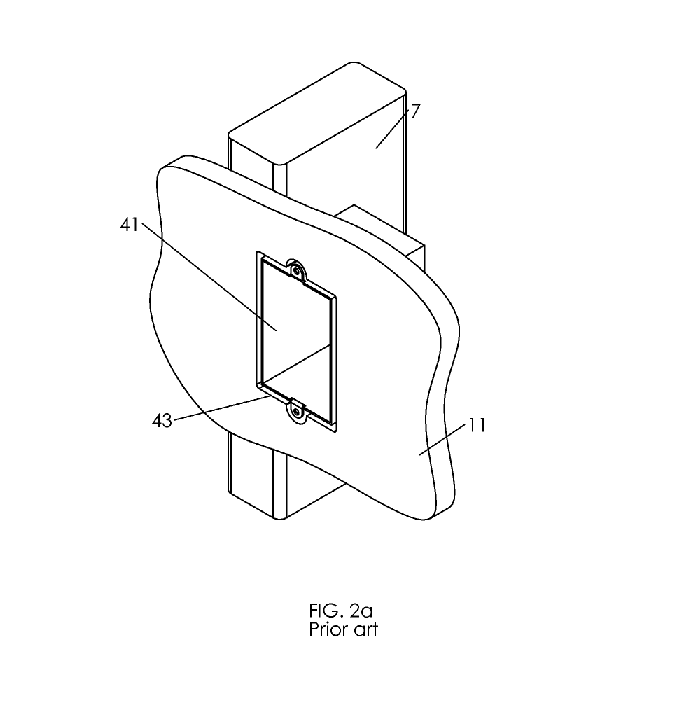

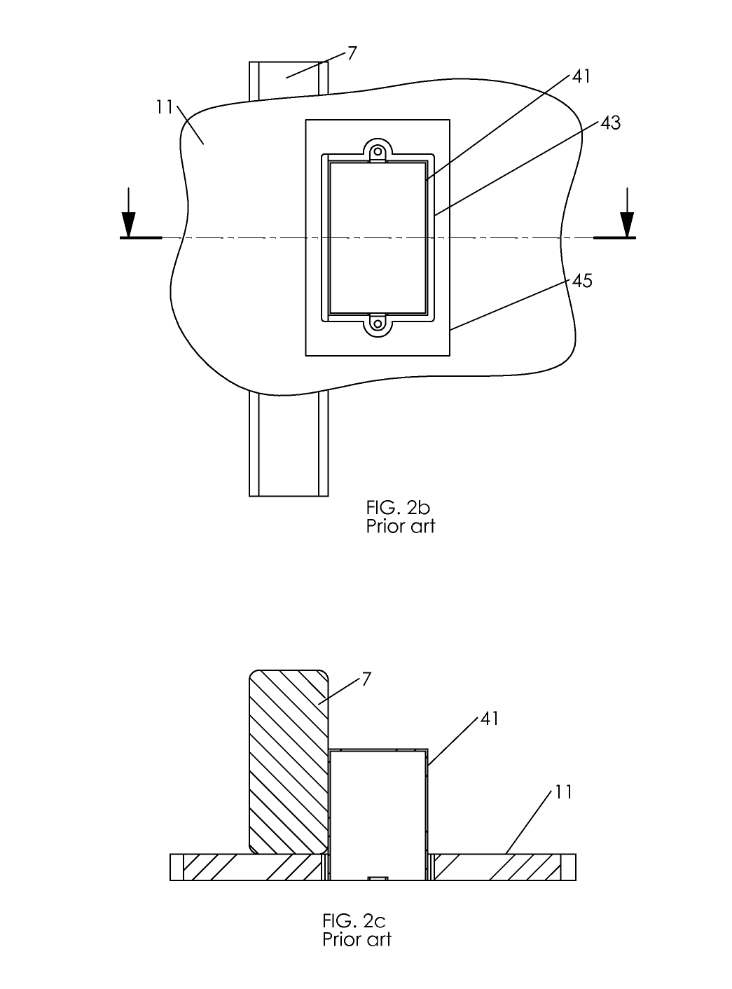

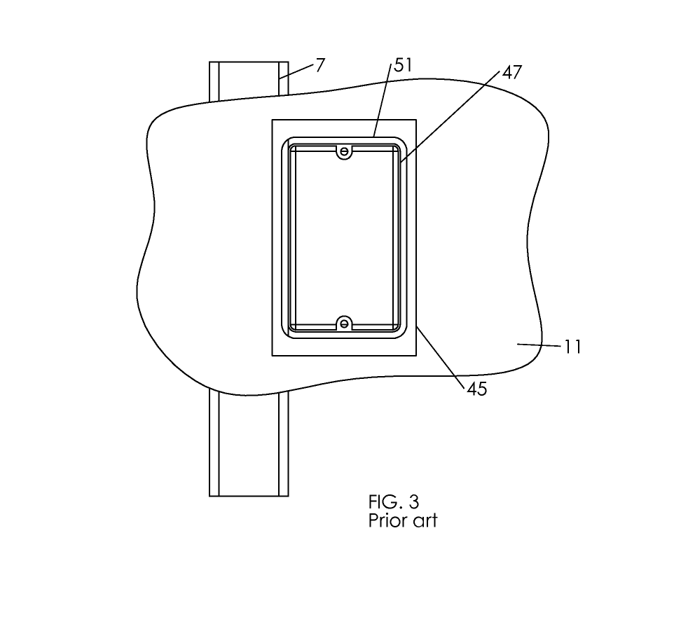

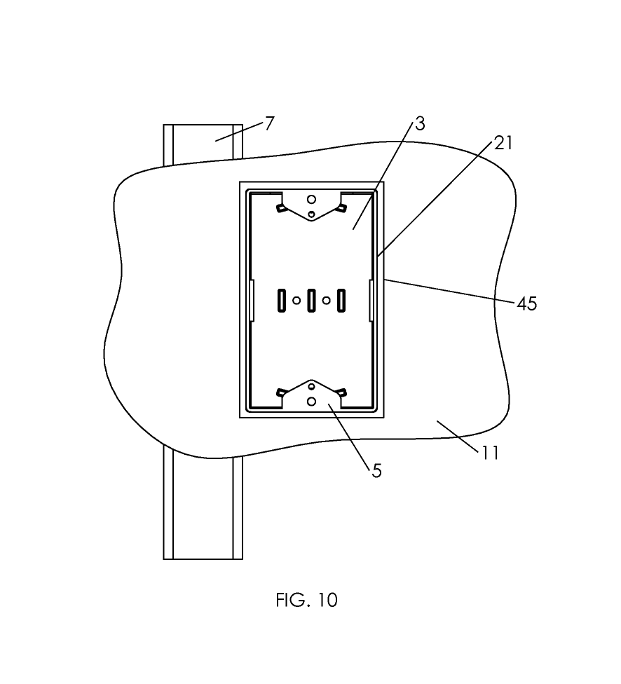

FIG. 10 illustrates box 3 and sleeve 5, with cut opening 21 in drywall 11 and a conventional cover plate perimeter line 45. Because drywall 11 is cut on the inside of box 3, the front of box 3 can have a larger opening than conventional boxes 41 and 47, depicted in prior art FIGS. 1 and 3, while employing the same conventional cover plate 39 with perimeter line 45. The clearance between opening 21 and the outside of the cover plate 39, perimeter line 45, can be much smaller than the conventional arrangement because there is much less chance of oversizing opening 21 when cutting bit 15 is confined to the inside of box 3, eliminating the possibility of no tool wander. As there is no chance of blowout, opening 21 can be closer in size to the outside of cover plate 39.

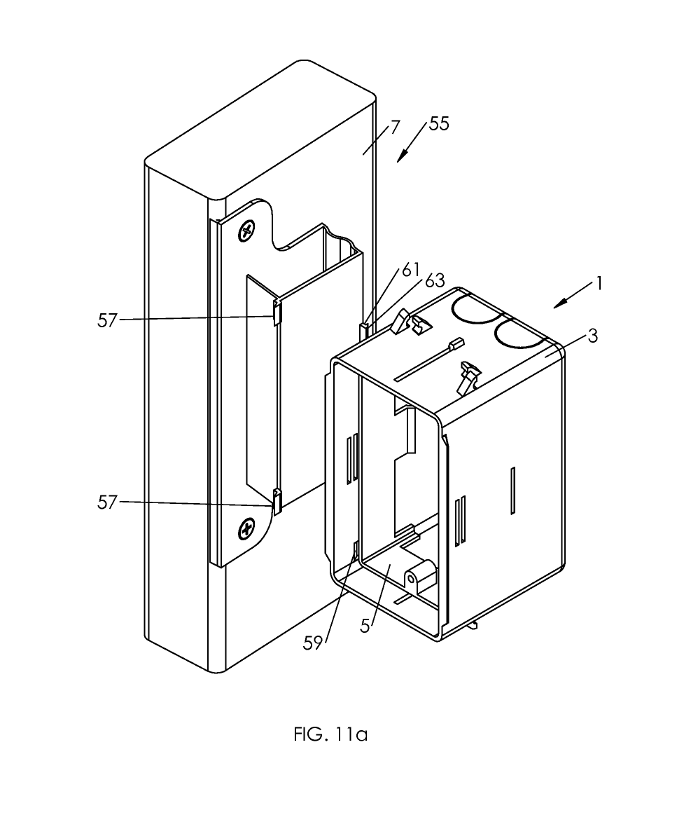

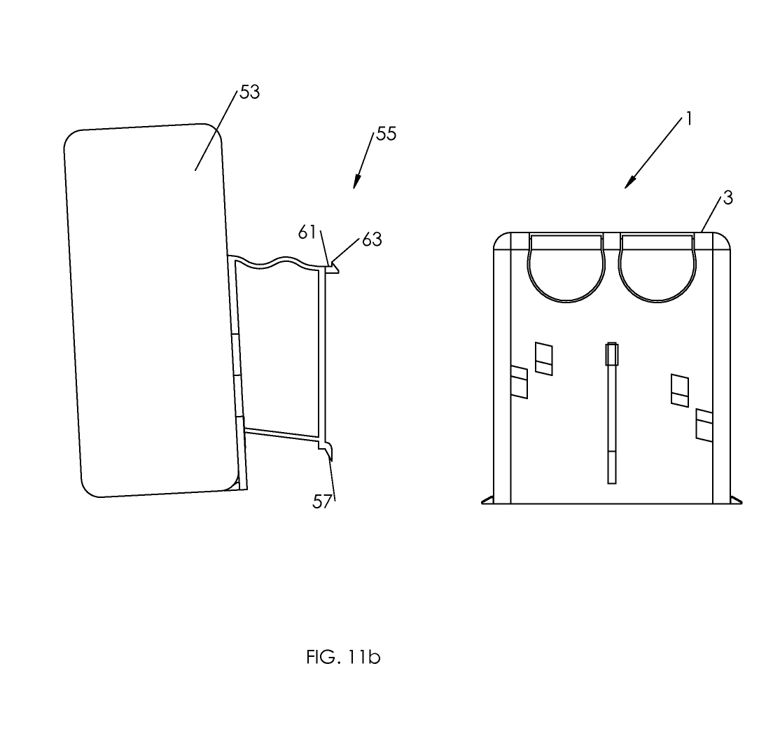

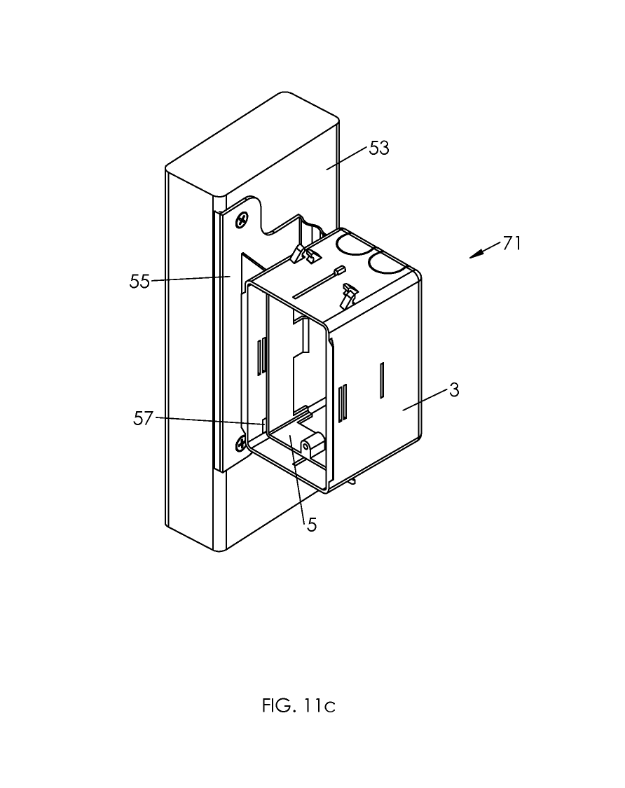

FIGS. 11a and 11b are an exploded isometric view and plan view, respectively, of self-aligning bracket 55 mounted to twisted stud 53 in combination with a box assembly 1 such as illustrated in FIGS. 5-10. Hooks 57 of bracket 55 are receivable by recesses 59 in box 3 and barbs 63 of bracket 55 are receivable by recesses 65 in box 3. Box 3 is pivotable about hooks 57. Beam 61, with barb 63 secures box 3 to bracket 55 to form box bracket assembly 71, shown in FIG. 11c. The bracket 55 is coupled to box 63 via mounted bracket flex plate 66 and undulated plate 67, as shown in FIG. 11e.

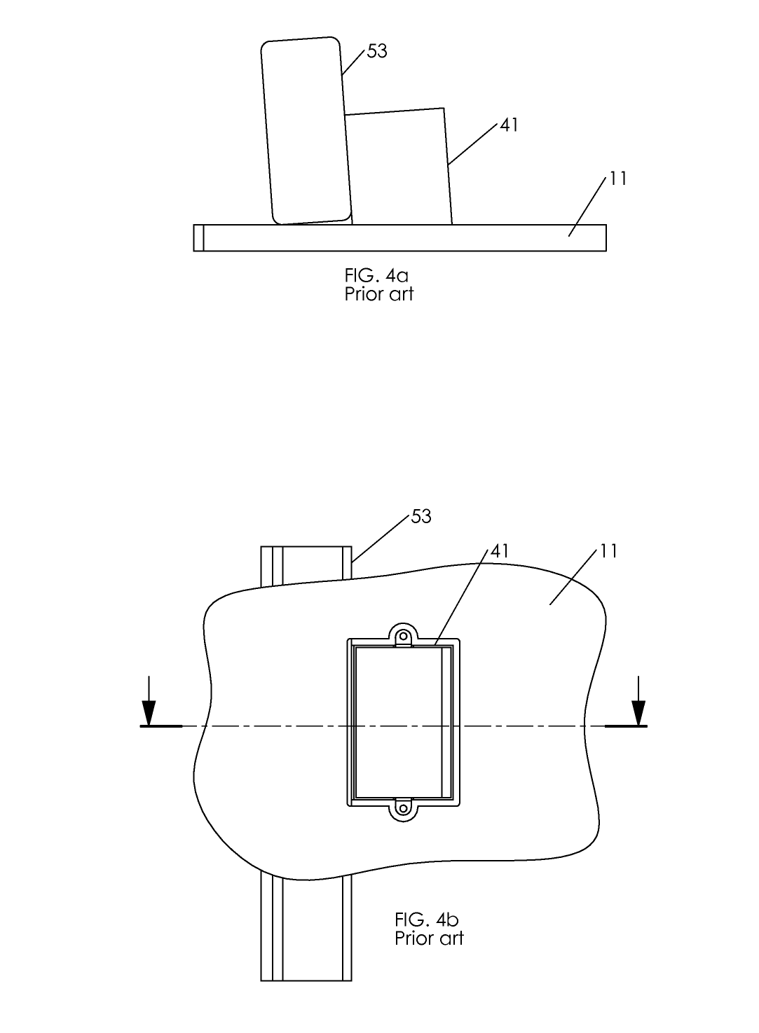

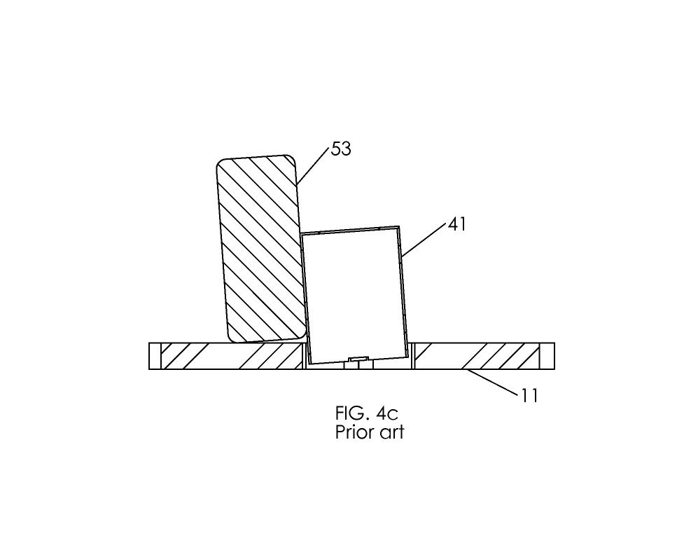

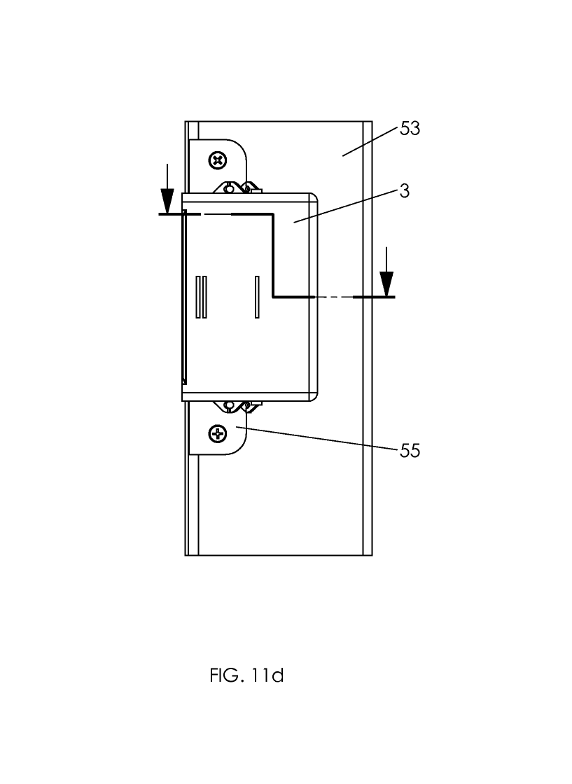

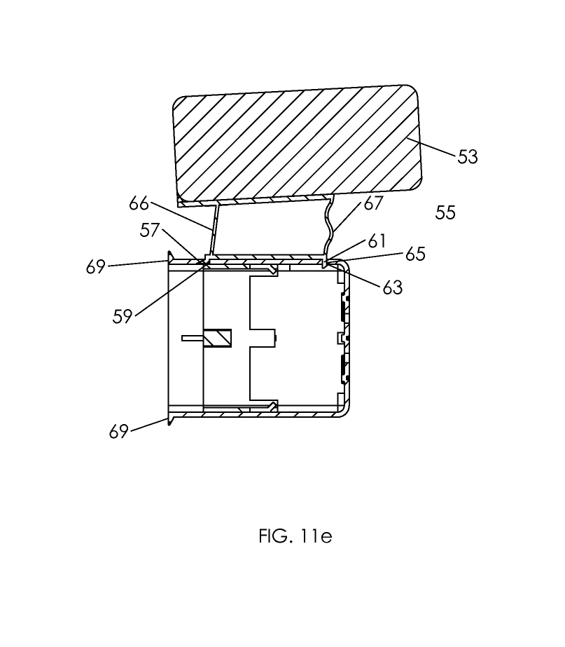

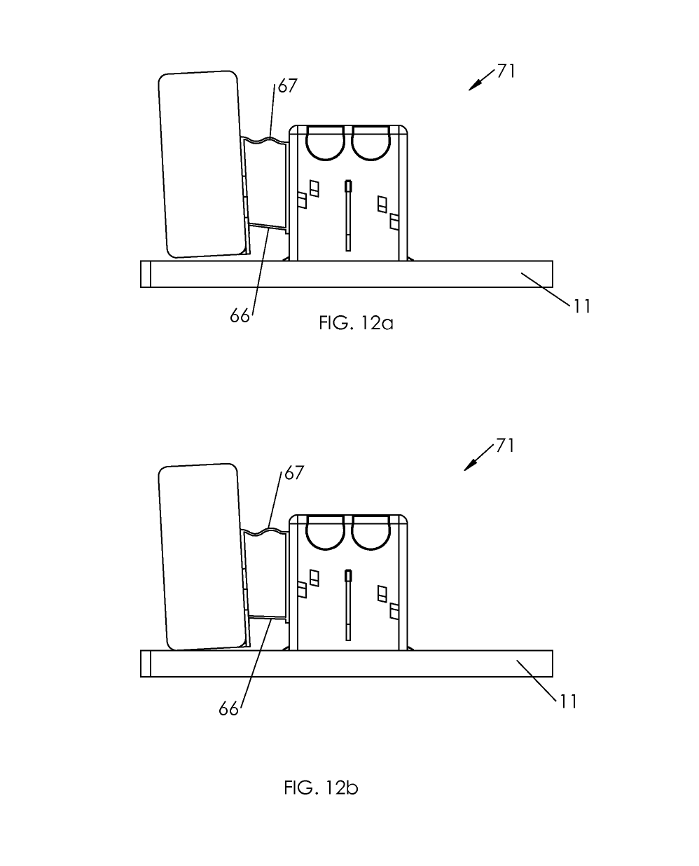

FIG. 12a is a plan view showing box bracket assembly 71 mounted to twisted stud 53 with drywall 11 positioned in front of it. Twisted stud 53 is not square to drywall 11. FIG. 12b shows the drywall fastened to stud 53. When drywall 11 is mounted, flex plate 66 and undulated plate 67 flex to allow front surface 69 of box 63 to rest flush with the back of drywall 11. Plate 66 and undulated plate 67 deform rearward with plate 67 compressed. Bracket 55 is flexible enough to deform as the drywall is screwed to the stud if twisted. The bracket is rigid enough that the inside perimeter of the box can be used as a cutting guide. Flex plate 66 does not change length so the normal forces from the guide tip of the cutting tool will not move the box from side to side nor will it allow the box to move vertically. This assembly overcomes the problem exhibited in prior art FIGS. 4a-4c.

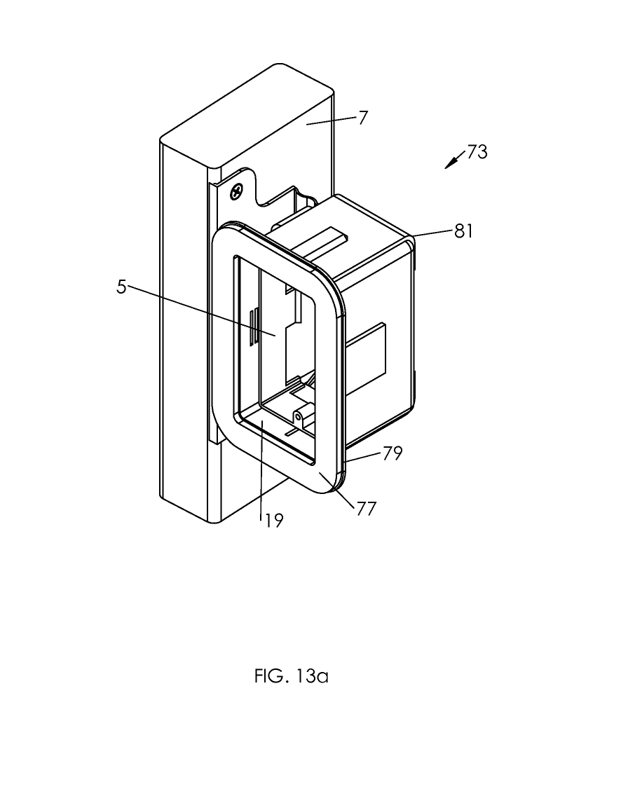

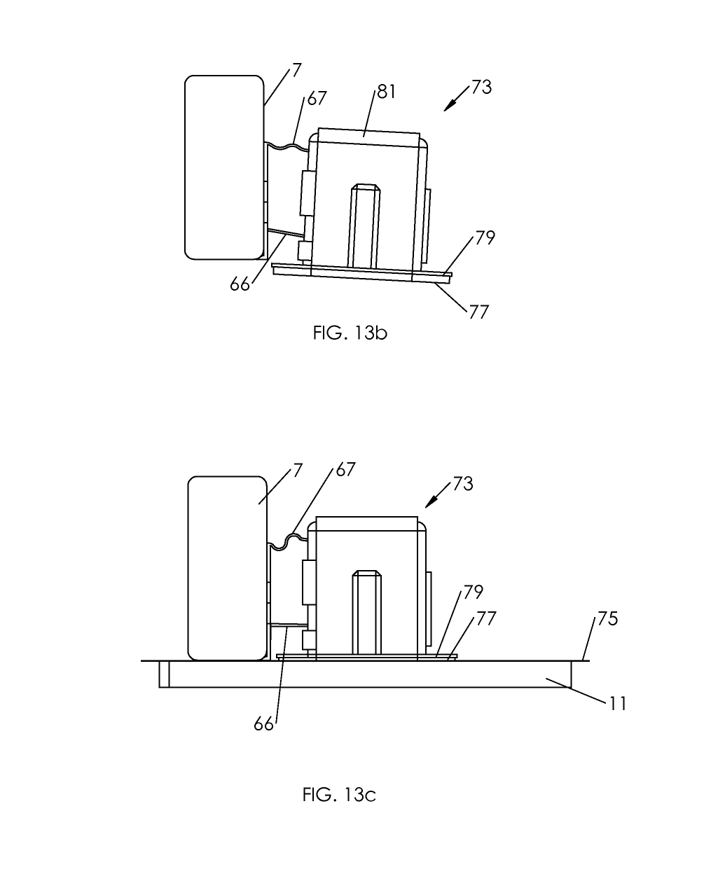

FIGS. 13a-13b show isometric and plan views respectively of vapour barrier box 73 with an integral self-aligning bracket similar to box bracket assembly 71 shown in FIGS. 11a-11c. FIG. 13c shows a plan view of vapour barrier box 73 with drywall 11 and vapour barrier membrane 75. Vapour box bracket 73 is mounted to stud 7 then vapour barrier membrane 75 is tacked to the stud 7 in the conventional manner before drywall 11 is fastened to studs 7. Closed cell foam 77, glued to surface 79 of box 73, is compressed due to deflection of flex plate 66 and undulated plate 67. If stud 7 is twisted, flex plate 66 and undulated plate 67 give vapour barrier box bracket 73 sufficient range of motion to align flat on the backside of drywall 11. Drywall 11 and vapour barrier membrane 75 is then cut as previously described by running cutting bit 17 along inner perimeter surface 19 and sleeve 5 is slid forward to enclose box 73 through the thickness of drywall 11. Vapour barrier box 73 is enclosed by limiting openings and covering apertures with closed cell foam 81 in the conventional manner. Box 73 ensures that there is sufficient compression of foam 77 to create a seal with vapour barrier membrane 75. A box arrangement of the prior art, described above, will not necessarily sit flat against the back of the drywall with a twisted stud and a seal will not be formed.

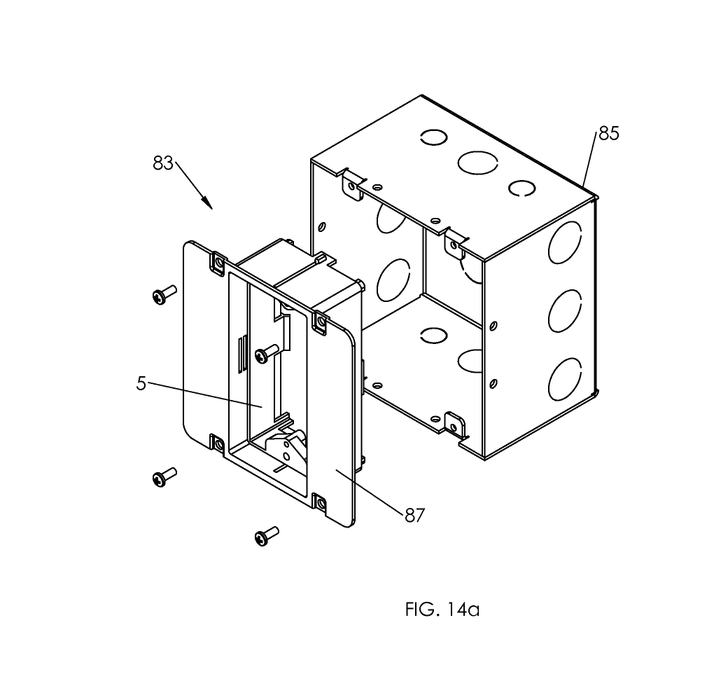

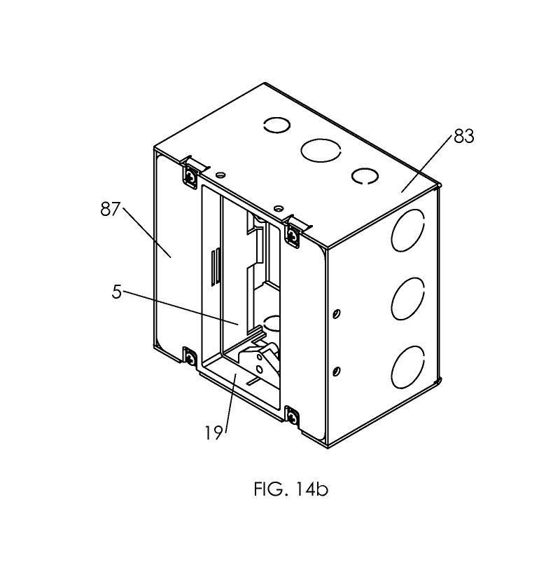

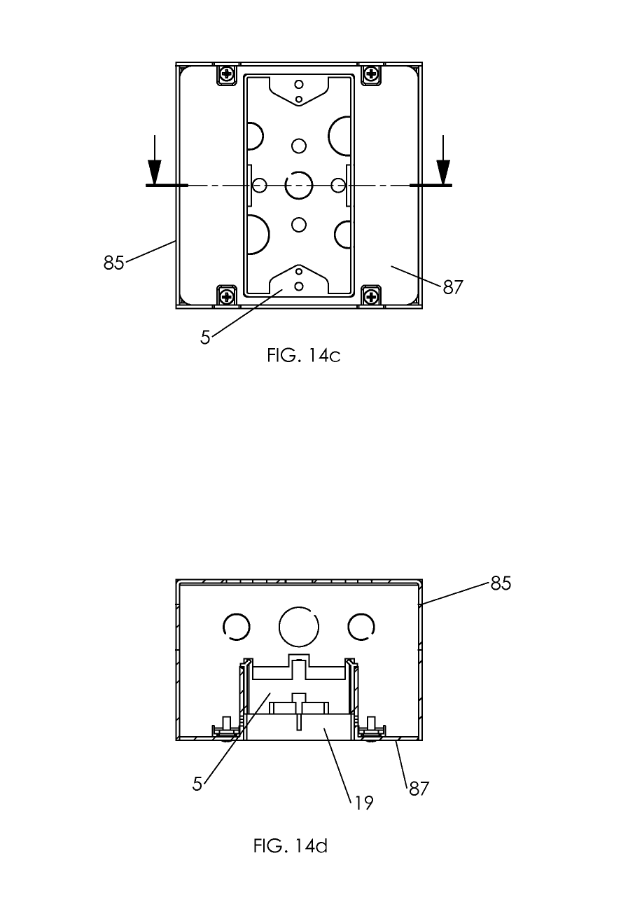

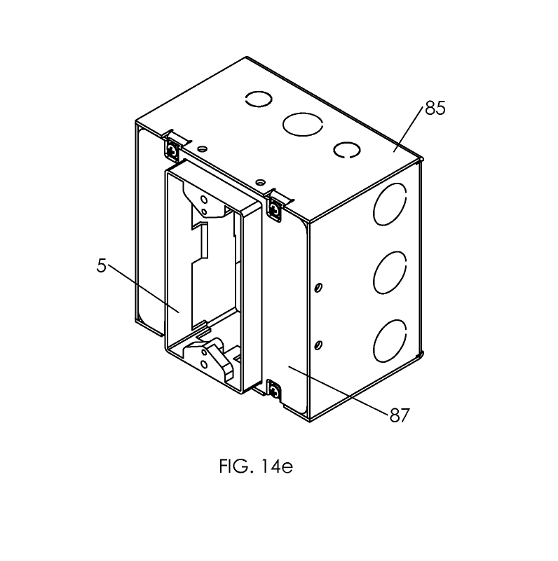

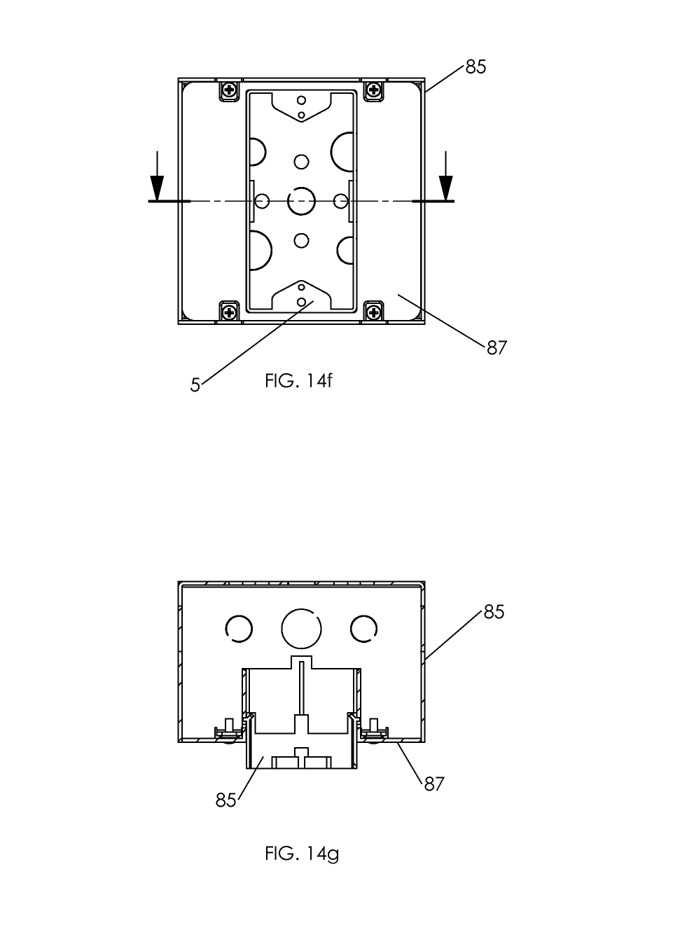

FIG. 14a is an exploded isometric view of collar sleeve assembly 83 applied with a conventional square electrical box 85. Collar sleeve assembly 83 comprises collar 87 and sleeve 5. Fasteners are used to secure collar sleeve assembly 83 to box 85, shown in FIG. 14b. Box 85 can be mounted directly to the wall stud with a conventional mud ring, the front of the box being flush with the front of the stud. Collar 87 has inner perimeter surface 19 that facilitates drywall cutting as described earlier.

Collar 87 includes a walled enclosure that interacts with sleeve 83. The enclosure includes the slot and recesses described with respect to FIGS. 5-8. The sleeve includes the rib and beam features described with respect to FIGS. 5-8. In FIG. 14b the assembly is shown with the sleeve in the retracted position. In FIG. 14e the assembly is shown with the sleeve in the extended position.

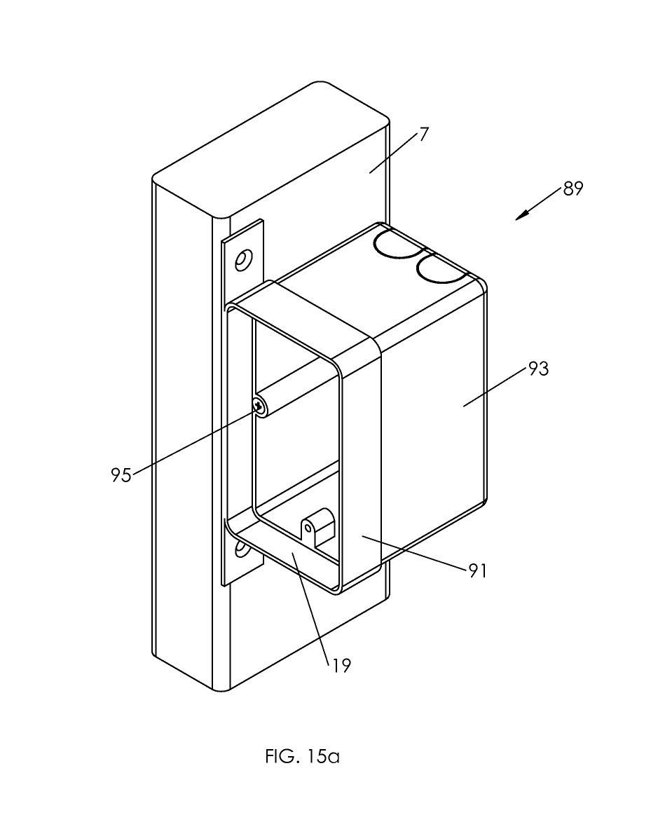

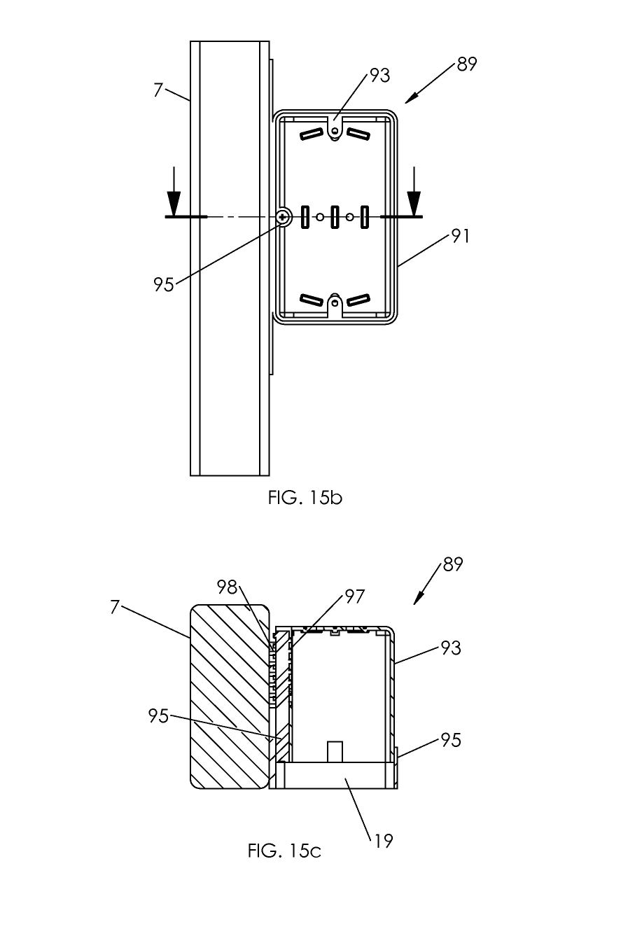

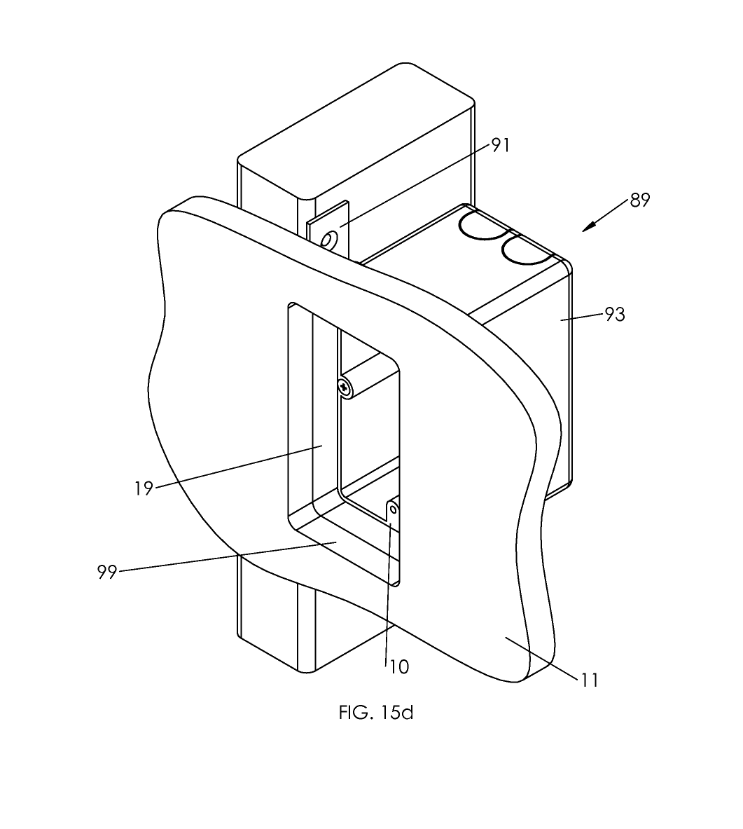

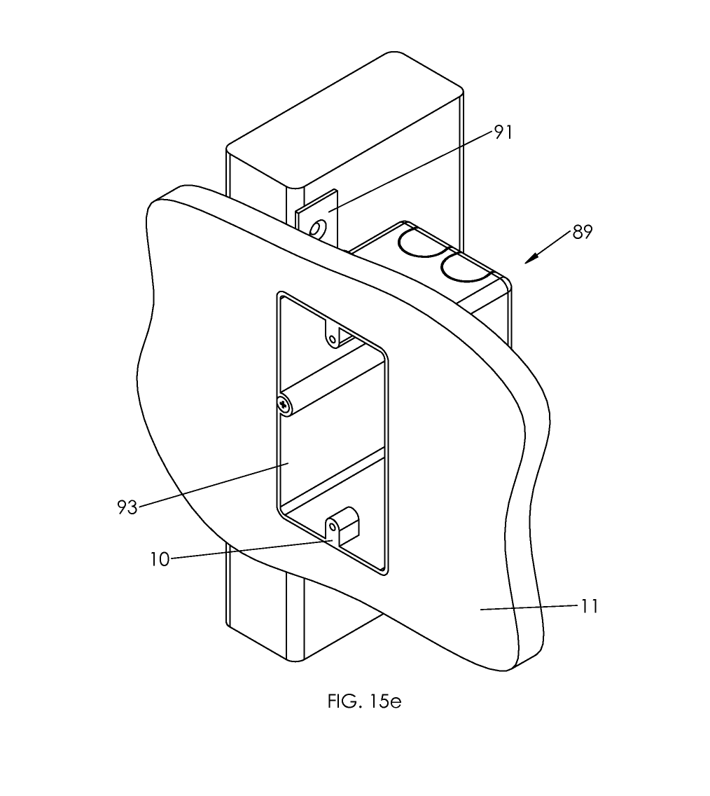

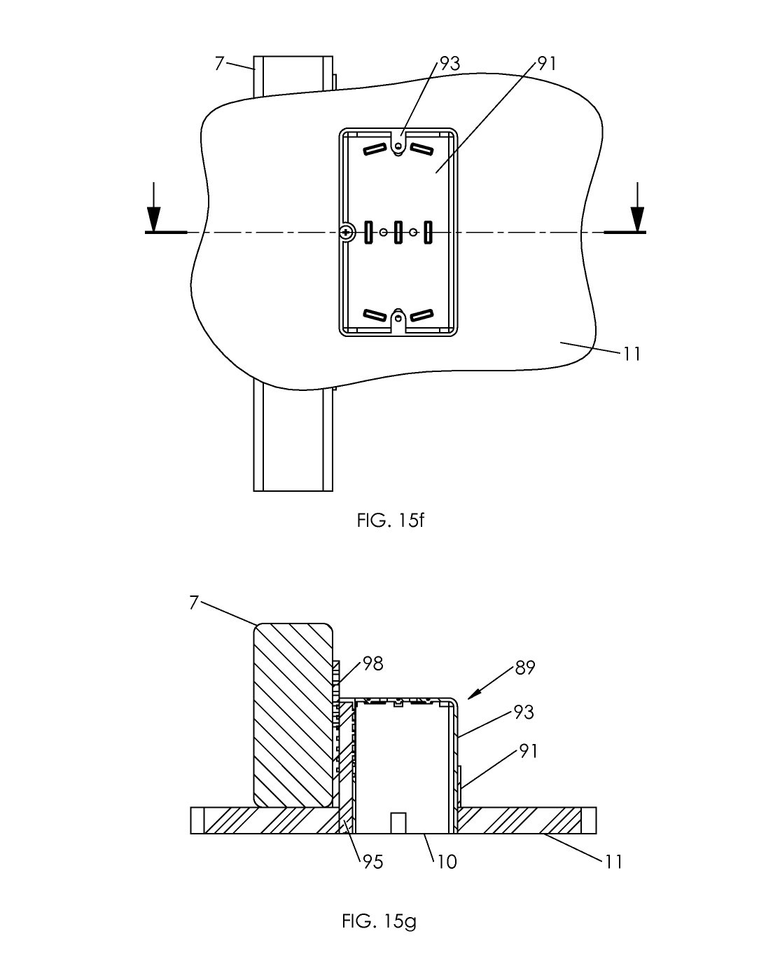

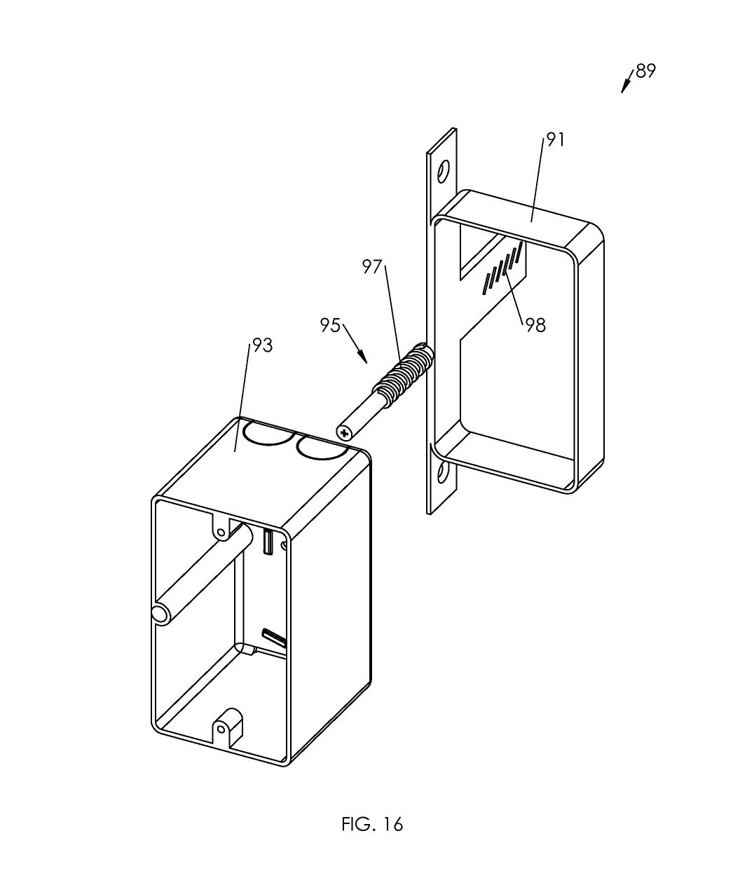

FIGS. 15a and 15b are isometric and front views, respectively, of bracket box assembly 89 mounted to stud 7. FIG. 15c is a section from FIG. 15c. Bracket 91 is mounted flush with the front of stud 7 with fasteners. Box 93 is held within bracket 91 and shown in the retracted state. Inner perimeter surface 19 of bracket 91 serves as surface within which the drywall cutting tool guide tip runs along. Screw 95 rotates freely within box 93. Male threads of screw 95 engage female threads 98 on bracket 91. Rotation of screw 95 controls the depth of box 93 within bracket 91. FIG. 15d is an isometric view with drywall 11 mounted over bracket box assembly 89 with opening 99 formed in the drywall. Thereafter, 93 is advanced by activation of screw 95 until front surface 10 is aligned with the front of drywall 11 as shown in FIG. 15e. The completed installation is illustrated in the front view of FIG. 15 f and section view of FIG. 15g. FIG. 16 shows an isometric exploded view of collar box assembly 89.

In this disclosure there are shown and described only preferred embodiments of the invention and but a few examples of its versatility. It is to be understood that the invention is capable of use in various other combinations and environments and is capable of changes or modifications within the scope of the inventive concept as expressed herein. It should be understood that the term “drywall” as used throughout the disclosure is representative of any wall substrate. Similarly, it should be understood that the concepts disclosed herein are applicable to other electrical devices that are supportable within a building wall surface.

For examples, a box extender can be installed for a thicker drywall. Sleeves of variable depths are envisioned, as are boxes with more recesses to accommodate more wall substrate thicknesses. Switching out a sleeve after substrate has been mounted also is within the concepts disclosed. The concepts are further applicable to boxes of different shapes and dimensions, such as a circular box, an octagon box and multi gang boxes of varying depths.

The figures in this patent application are illustrative of boxes with different styles of knockouts and wire access ports. Any type of wiring may be employed with these boxes regardless of the type shown as the openings may vary in shape and size.

What is claimed is:

1. An assembly comprising:
a box structure mountable to a building wall stud in a mounted position, the box structure formed as a walled enclosure for at least one electrical device, a front end of the enclosure having an inner periphery defining an opening in a building wall substrate; and
a sleeve engaged with the box structure, the sleeve slidable between a retracted sleeve position, wherein the sleeve is entirely within the walled enclosure, and an extended sleeve position, wherein the sleeve is partially outward of the walled enclosure;
wherein the front end of the enclosure is aligned with a front of the stud in the mounted position, and a front end of the sleeve is aligned with an outer surface of the building wall substrate in the extended sleeve position.

2. An assembly as recited in claim 1, wherein:
the enclosure comprises a slot in a wall thereof;
the sleeve comprises a rib protruding through the slot of the enclosure; and
a first end of the slot defines the extended sleeve position and a second end of the slot defines the retracted sleeve position.

3. An assembly as recited in claim 2, wherein the rib comprises a T-shaped end.

4. An assembly as recited in claim 2, wherein the sleeve further comprises a corner stabilizer.

5. An assembly as recited in claim 2, wherein:
the sleeve further comprises a sprung cantilevered beam, the beam formed with a barbed end;
the enclosure comprises at least one recess in a wall thereof; and
the barbed end of the beam is in engaged within the recess in the retracted sleeve position.

6. An assembly as recited in claim 5, wherein the enclosure comprises a second recess and the barbed end of the beam is engaged in the second recess in the extended sleeve position.

7. An assembly as recited in claim 6, wherein the enclosure comprises a third recess and the barbed end of the beam is engaged in the third recess in a sleeve position intermediate the retracted sleeve position and the extended sleeve position.

8. An assembly as recited in claim 5, wherein the at least one recess comprises a ramped configuration.

9. An assembly as recited in claim 5, wherein the beam further comprises a tab fixed to the barbed end.

10. An assembly as recited in claim 1, wherein:
the sleeve further comprises a sprung cantilevered beam, the beam formed with a barbed end;
the enclosure comprises at least one recess in a wall thereof; and
the barbed end of the beam is in engaged within the recess in the retracted sleeve position.

11. An assembly as recited in claim 10, wherein the enclosure comprises a second recess and the barbed end of the beam is engaged in the second recess in the extended sleeve position.

12. An assembly as recited in claim 1, wherein the sleeve further comprises a device mounting surface.

13. An assembly as recited in claim 1, further comprising a bracket engageable with the box enclosure.

14. An assembly as recited in claim 13, wherein the bracket comprises
a side portion mountable to the stud;
a first flexible plate extending from the side portion; and
a second flexible plate extending from the side portion.

15. An assembly as recited in claim 14, wherein:
a wall of the box enclosure comprises a plurality of recesses;
the first flexible plate comprises as least one hook pivotably received by one of the plurality of recesses; and
the second flexible plate comprises at least one barb engaged with another of the plurality of recesses.

16. An assembly comprising:
a box structure mountable to a building wall stud in a mounted position; and
a sleeve assembly fixed to the box structure, the sleeve assembly comprising:
a walled enclosure for at least one electrical device, a front end of the enclosure having an inner periphery defining an opening in a building wall substrate; and
a sleeve engaged with the walled enclosure, the sleeve slidable with respect to the sleeve walled enclosure between a retracted sleeve position, wherein the sleeve is entirely within the walled enclosure, and an extended sleeve position, wherein the sleeve is partially outward of the walled enclosure; and
wherein the front end of the enclosure is aligned with a front of the stud in the mounted position, and a front end of the sleeve is aligned with an outer surface of the building wall substrate in the extended sleeve position.

17. An assembly comprising:
a bracket mountable to a building wall stud in a mounted position, an inner periphery of the bracket defining an opening in a building wall substrate; and
an electrical box structure surrounded by the bracket; wherein:
the bracket comprises a female threaded portion, a front of the bracket is aligned with a front edge of the stud in the mounted position; and
the box comprises a male threaded rotatable element engaged with the female threaded portion of the bracket.

18. An assembly as recited in claim 18, wherein the female threaded portion is dimensioned in length to correspond to a selective range of travel of the box between:
alignment with the front of the bracket at one end of the range of travel, and
a position extending position outwardly from the front of the bracket at an opposite end of the range of travel.
